(19) United States
(12) Patent Application Publication
(10) Pub. No.: US 2009/0068461 A1
(43) Pub. Date: Mar. 12, 2009

(54) CARBON NANOTUBES ON CARBON NANOFIBER SUBSTRATE

(75) Inventors: Darrell H. Reneker, Akron, OH (US); Haoqing Hou, Nanchang (CN)

Correspondence Address: ROETZEL AND ANDRESS, 222 SOUTH MAIN STREET, AKRON, OH, 44308, US

(73) Assignee: THE UNIVERSITY OF AKRON, Akron, OH (US)

(21) Appl. No.: 10/595,402

(22) PCT Filed: Oct. 18, 2004
(86) PCT No.: PCT/US2004/034274

§ 371 Date: Nov. 25, 2008

Related U.S. Application Data
(60) Provisional application No. 60/511,977, filed on Oct. 16, 2003.

(51) Int. Cl. B32B 9/00; D01D 5/30

(52) U.S. Cl. 428/366; 428/373; 264/484; 977/843; 977/844; 977/848; 977/932; 977/953

(57) ABSTRACT

A hierarchical structure that has at least one carbon nanotube extending radially from a nanofiber substrate and related methods of use and manufacture.

### BACKGROUND OF THE INVENTION

Carbon nanotubes and methods for their manufacture are known. Since their discovery they've sparked widespread interest because of their unique structure and extraordinary mechanical and electronic properties. Their high strength-to-weight ratio makes them one of the stiffest materials ever made. Whereas traditional carbon fibers have a strength-to-weight ratio about 40 times that of steel, carbon nanotubes have a strength-to-weight ratio of at least 2 orders of magnitude greater than steel. They also demonstrate outstanding flexibility and elasticity. Theoretical studies suggest a Young's modulus as high as 1-5 Tpa, and some measurements have provided an average value of 2 Tpa. Being graphitic, one expects carbon nanotubes to show high chemical and thermal stability. Recent oxidation studies have shown that the onset of oxidation shifts by about 100° C. to higher temperatures in carbon nanotubes compared to graphite fibers. Theoretical considerations predict that carbon nanotubes will show high thermal conductivity in the axial direction.

It's known that a carbon-nanotube wall is constructed such that a single carbon atom is bonded to three adjacent carbon atoms. A repeating hexagonal-ring formation results and provides the structural make up of a nanotube's cylindrical wall(s). The cylindrical structure is further characterized by a diameter that can range anywhere from a single nanometer to several tens of nanometers. Nanotube lengths range from about ten to about several thousand times that of the diameter.

Carbon nanotubes are helical microtubules of graphitic carbon. The simplest carbon nanotubes are single-walled, i.e., a tube formed from a graphitic sheet rolled up on itself with a helical pitch and joined seamlessly at the edges. Usually such tubes are capped at the end to afford a closed tubule with a conical cap. Single-walled carbon-nanotube diameters of 10-20 Angstroms are common. Multi-walled carbon nanotubes are one step up in complexity and consist of a multiplicity of concentric tubes, either formed by closure of a graphitic sheet or formed by a structure having a series of walls in a spiral formation. The distance between concentric tubes is typically about 0.34 nm, which is also the spacing between sheets of graphite. Multi-walled carbon nanotubes may contain only 2 concentric tubes, or may contain 50 or more concentric tubes.

Synthetic methods for forming carbon nanotubes include arc-discharge, laser ablation, gas-phase catalytic growth from carbon monoxide, and chemical vapor deposition (CVD) from hydrocarbons. Silicon crystals, quartz glass, porous silicon dioxide, and aluminum oxide are well-known prior-art substrates for growing carbon nanotubes. Carbon nanotubes collected from these substrates are used in making carbon-nanotube composites for gas storage and electrochemical-energy storage.

CVD methods for manufacturing carbon nanotubes tend to produce multiwall nanotubes attached to a substrate, often with a semi-aligned or aligned parallel growth perpendicular to the substrate. Catalytic decomposition of hydrocarbon-containing precursors such as ethylene, methane, or benzene creates a secondary-carbon source that produces carbon nanotubes when the reaction parameters, such as temperature, time, precursor concentration, and flow rate are optimized. Nucleation layers such as a thin coating of Ni, Co, Fe, etc. are often intentionally added to the substrate surface to nucleate or catalyze the growth of a multiplicity of isolated nanotubes. Carbon nanotubes can also be nucleated and grown on a substrate without using such a metal nucleating layer, e.g., by using a hydrocarbon-containing precursor mixed with a chemical component (such as ferrocene) that contains one or more of these catalytic metal atoms. During CVD, these catalytic metal atoms serve to nucleate the nanotubes on the substrate surface.

U.S. Pat. No. 5,753,088 to Olk is generally directed to a carbon-nanotube manufacturing method, and involves immersing carbon anode and cathode electrodes into liquid nitrogen, helium, or hydrogen and passing a direct current between the electrodes thereby growing carbon nanotubes on the cathode surface.

U.S. Pat. No. 5,424,054 issued to Bethune et al. teaches a method for manufacturing carbon fibers or tubes having a wall thickness equal to a single layer of carbon atoms. The method uses arc discharge between a carbon-rod cathode and a hollowed-out anode containing cobalt catalyst/carbon powder. The reaction takes place in an inert atmosphere.

U.S. Pat. Nos. 5,830,326 and 5,747,161 to Lijima teach a method for manufacturing carbon nanotubes using direct-current discharge between carbon electrodes in a noble gas atmosphere that is preferably argon.

U.S. Pat. No. 5,413,866 to Baker et al. is directed to carbon filaments produced by using a thermal gas-phase growth process in which a carbon-containing gas is decomposed in the presence of a catalyst coated substrate. The type of metal catalyst employed in the reaction affects the resultant carbon-filament structure.

U.S. Pat. No. 5,457,343 to Ajayan et al. discloses carbon nanotubes containing foreign materials, in other words a carbon nanotube used as a storage device. The nanotubes are produced in an inert atmosphere using an electric-discharge method.

U.S. Pat. No. 5,489,477 to Ohta et al. is directed to a method for producing high-molecular-weight carbon materials incorporating C₆₀ fullerene structures.

U.S. patent application Ser. No. 09/133,948 to Dai et al. describes a catalytic chemical vapor deposition (CVD) technique that uses catalyst islands to grow individual nanotubes for atomic force microscopy applications. A catalyst island includes a catalyst particle that is capable of growing carbon nanotubes when exposed to a hydrocarbon gas at elevated temperatures. A carbon nanotube extends from the catalyst particle. In this way, nanotube atomic-force microscopy tips have been obtained by attaching multi- and single-walled nanotube bundles to the sides of silicon pyramidal tips.

There remains in the art a need for nanotubes grown on additional substrates and methods relating thereto.

### BRIEF SUMMARY OF THE INVENTION

In general the present invention provides a composition comprising: a first nanotube attached to a fiber.

The present invention also includes a method comprising the step of: growing a nanotube on a fiber substrate.

The present invention further provides a method comprising the step of: growing a nanotube on a fiber substrate.

The present invention further provides a method comprising the step of: growing a second nanotube on a first nanotube substrate.

A method for manufacturing a metal-containing nanofiber comprising the steps of: electrospinning a solution comprising an electrospinnable polymer and at least one metal to produce a metal-containing nanofiber; and carbonizing the resultant metal-containing nanofiber.

Hierarchical structures are electrically conductive and a structure's metallic particles often exhibit catalytic properties for redox reactions. For example, electrons may flow through the tree-like structure either toward or away from the metal particles. The hierarchical structures can be manufactured to have relatively high concentrations of metal particles per unit volume, which allows for catalyzing a relatively large number of redox reactions per unit volume.

An electrically conductive membrane with a large specific surface area that supports catalytic metal nanoparticles is a highly effective electrode for a fuel cell (H₂—O₂), for example. Prior to this invention no membrane structure with such a large number of well-supported accessible particles per unit volume was known.

An advantage of the invented structure is its large specific surface area, electrical conductivity, excellent dispersion of metal nanoparticles on long fibers, chemical inertness, and dendritic structure. The structure has almost the same conductivity as graphite, the specific surface area of the invented structure is above 100 m²/g and that is 10-15 times larger than that of the carbonized electrospun nanofibers by calculation, and the metal-catalyst particles were found at the tip of every nanotube on the electrospun fiber.

### BRIEF DESCRIPTION OF THE FIGURES

FIG. 1. (A). SEM image of electrospun hybrid nanofibers of PAN and Pt(Acc)₂; (B). TEM image of hybrid nanofibers of carbon and Pd nanoparticle, (C). TEM image of carbon nanotubes growing on the surface of the Pd nanoparticle hybrid carbon nanofiber; (D). TEM image of conductive polyacetylene nanofibers growing out from the electrospun Cu nanoparticle hybrid carbon nanofiber.

FIG. 2. Transmission (A) and scanning (B) electron micrographs of carbon nanotubes on carbon nanofibers. These structures were produced by electrospinning of polyacrylonitrile nanofibers, carbonization of the polyacrylonitrile, followed by catalytic growth of carbon nanotubes by pyrolysis of hexane.

FIG. 3. Transmission (A) and scanning (B) electron micrographs of CNT-CNF produced by electrospinning of polyacrylonitrile nanofibers, carbonization of the polyacrylonitrile, and catalytic growth of carbon nanotubes.

FIG. 4. Transmission (A) and scanning (B) electron microscopic pictures of dendritic structures of carbon nanotubes on carbon nanofibers.

FIG. 5. (A) scanning electron micrograph of composite nanofibers of PAN and Fe(Acc)₃ produced by electrospinning process; (B) transmission electron micrograph of carbonized electrospun nanofibers containing Fe nanoparticles produced by carbonization of the composite nanofibers of PAN and Fe(Acc)₃ as well as a reduction of Fe³⁺ in H₂ atmosphere at 500-550° C. The insert shows some segments of the nanofibers at higher magnification.

FIG. 6. (A) Scanning electron micrograph of composite nanofibers of PAN and Fe(Acc)₃ produced by electrospinning process. (B) and (C) transmission electron micrographs of carbonized PAN nanofibers containing Fe nanoparticles, made from precursor PAN nanofibers with a ratio of Fe(Acc)₃/PAN=1/2 for (B) and 1/1 for (C).

FIG. 7. Transmission electron microscopic images of hierarchical structures of carbon nanotubes on carbon nanofibers, in which the first-class carbon nanotubes grew on carbon nanofiber and the second-class carbon nanotubes grew on the first-class carbon nanotubes.

FIG. 8. Scanning (A) and transmission (13) electron micrographs of carbon nanotubes on carbon nanofibers structure illustrate a sheet edge (A) and a very thin carbon nano-structure sheet supported by carbonized electrospun nanofibers (B).

FIG. 9. Transmission electron micrographs of carbon nano-structures illustrate the control of the length of carbon nanotubes by controlling the time during which the hexane vapor was supplied. From (A) to (C), the hexane vapor was supplied for 3, 5 and 20 min, respectively. The argon flow rate was 600 ml/min.

FIG. 10. Schematic of electrospinning set-up for manufacturing polyacrylonitrile nanofibers that contained metal-organic compounds.

FIG. 11. Scanning (A and B) and transmission (C and D) electron micrographs of a thin sheet of CNT-CNF. A torn edge of a sheet is shown in (A). The surface of a sheet of tangled nanotubes is shown in (B). (C) shows a thinner sheet in which the carbonized nanofibers are evident and the interstices are filled with nanotubes. (D) is a higher magnification image of a part of the nanotube sheet in (C) that is between the carbon nanofibers.

FIG. 12. Schematic of high temperature furnace for manufacturing carbonized electrospun nanofibers hybridized with metal nanoparticles or non-woven carbon nanotuber-on-fiber membranes.

FIG. 13. Transmission electron micrographs of carbon nano-structures. (A) Long, slightly curved carbon nanotubes formed at 850° C. (B) Curved and bent carbon nanotubes formed at 700° C.

FIG. 14. (A) Photograph of a piece of CNT-CNF sheet, with an area of 95 cm². (B) Transmission electron micrograph of CNT-CNF structure coated with palladium by plasma-enhanced sputtering.

### DETAILED DESCRIPTION OF THE INVENTION

Generally, this invention is directed to hierarchical structures having carbon nanotubes attached to carbon nanofibers (CNT-CNF). Preferably, these structures also have carbon nanotubes attached to carbon nanotubes (CNT-CNT).

In order to construct these hierarchical structures, a nanofiber substrate is provided from which at least one carbon nanotube is grown—thereby producing a CNT-CNF construction. The carbon nanofiber may be supported on conventional carbon fibers or other suitable macrostructures. That nanotube (i.e., the nanotube that is part of the CNT-CNF construction), in turn, preferably serves as a substrate upon which at least one additional nanotube(s) is grown—thereby producing a CNT-CNT construction.

The hierarchical structures are hereinbelow described in terms of their elements. A hierarchical element is either a nanofiber or nanotube that is part of the hierarchical structure. Each element of the structure is typically referred to as a first element, second element, third element, fourth element, and so on. These numerical-element terms describe an element's relative positioning within the hierarchical structure. For instance, a “first-element nanofiber” is the first or base element of the structure and serves as the substrate to which all additional nanotube elements are attached either directly or indirectly. More specifically, the first-element nanofiber acts as the substrate from which the second-element nanotube is grown and thereby attached (creating a CNT-CNF construction). A second-element nanotube preferably serves as the substrate upon which a third-element nanotube is attached (a CNT-CNT construction). Likewise, a third-element nanotube preferably serves as the substrate upon which a fourth-element nanotube is attached (a CNT-CNT construction).

Hierarchical structures are in no way limited to a maximum number of elements. So there can be anywhere from one to thousands or more of second-element nanotubes in a particular hierarchical structure. Likewise, there can be from one to thousands or more of third-element nanotubes. But because the first-element fiber serves as the base substrate for a hierarchical structure, there is only one first-element fiber per structure. The nanotube elements can be separated by distances as small as one nanometer, or they can be separated by large distances since a first-element nanofiber may be arbitrarily long.

This invention is further defined as a hierarchical structure having carbon-nanotube elements or a series of carbon-nanotube elements that are either directly or indirectly attached to a first-element nanofiber. Apart from the first-element nanofiber, all of a hierarchical structure's elements (second, third, fourth, and etc.) are nanotubes. As mentioned, the first-element nanofiber serves as the base substrate to which all subsequent-element nanotubes are directly or indirectly attached. Direct attachment occurs where a subsequent-element nanotube is attached to its substrate element, i.e., the immediately previous element, which is either a nanofiber or nanotube, via chemical bonding. An example of this is where a second-element nanotube is attached to a first-element nanofiber or where a third-element nanotube is attached to a second-element nanotube. Indirect attachment, on the other hand, occurs where an intermediate element or series of elements link nonconsecutive elements. An example of this is where a third-element nanotube is indirectly attached to a first-element nanofiber via a second-element nanotube. Another example of indirect attachment is where a fourth-element nanotube is indirectly attached to a first-element nanofiber via second and third-element nanotubes. Hierarchical structures have at least a first-element nanofiber directly attached to a second-element nanotube. And it is preferred that the hierarchical structures have subsequent-element nanotubes, e.g., third-element, fourth-element, and fifth-element nanotubes.

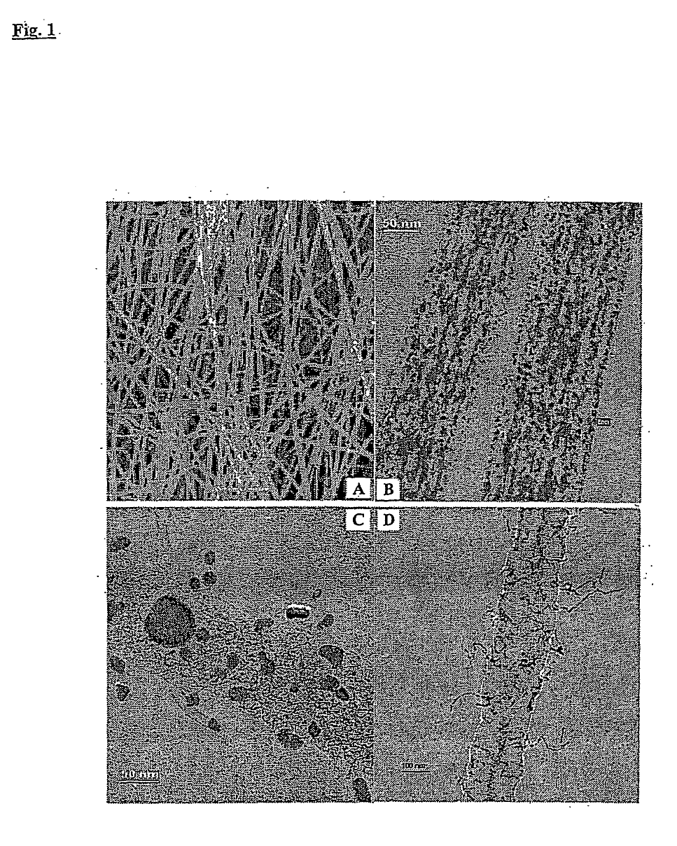

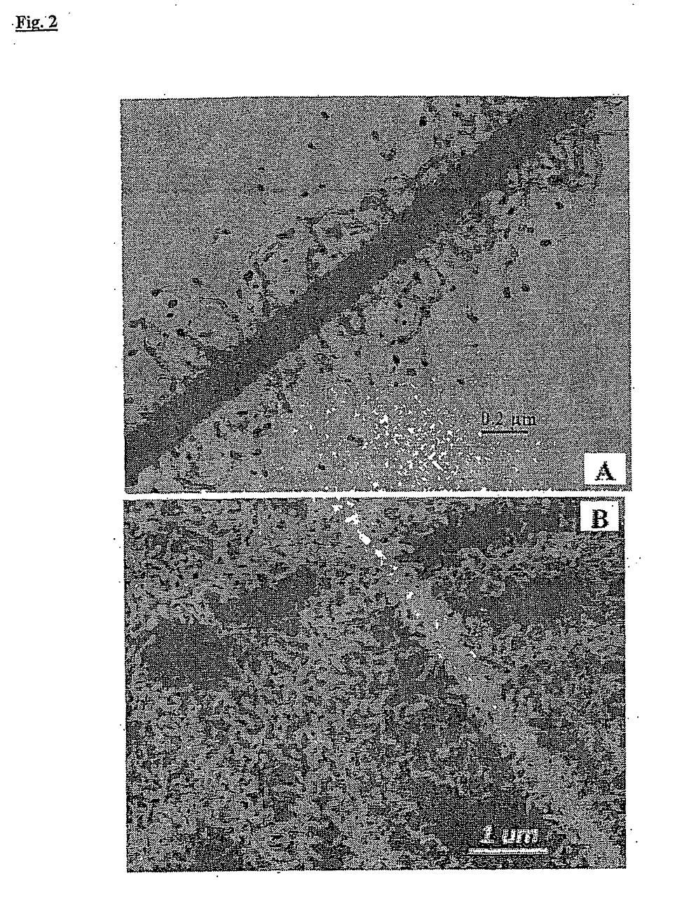

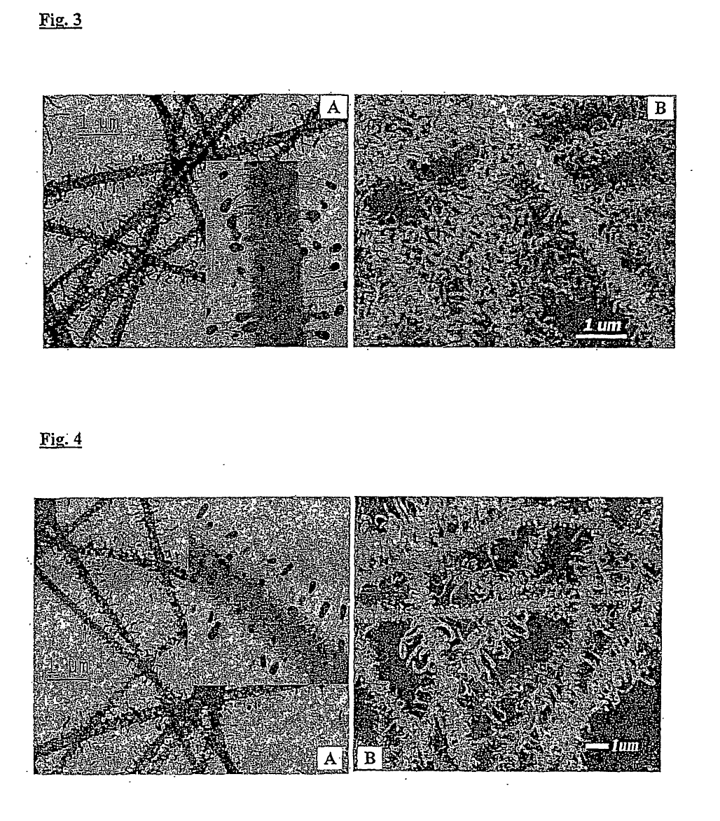

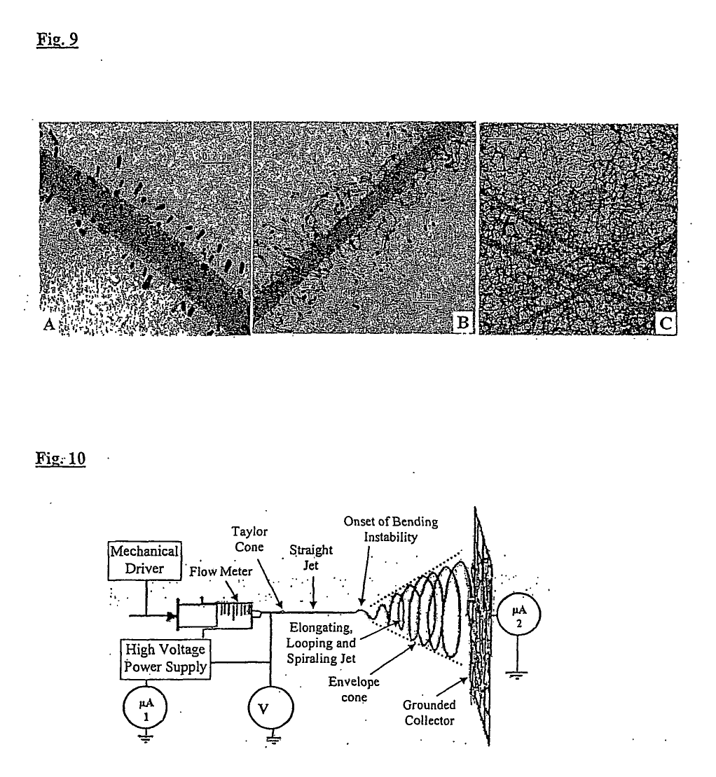

Preferably, a hierarchical structure is manufactured in such a way that its nanotubes extend from their respective substrate element in a substantially radial direction (i.e., second-element nanotubes branch off of the first-element nanofiber in an orthogonal direction and third-element nanotubes branch off of the second-element nanofiber in an orthogonal direction). As mentioned above, the construction of the hierarchical structure is such that each nanotube element, e.g., second, third, etc, —element nanotube, extends substantially radially from the immediately previous-element nanotube or nanofiber. This construction results in a branch-like structure and sub-branch-like structures. An example of such a construction is shown in FIGS. 1-14.

As mentioned above, a hierarchical structure's nanotubes preferably extend in a radial direction from their substrate element. Additionally, hierarchical structures can be manufactured by a method(s) that promotes the growth of next-element nanotubes on a selected portion of a substrate surface area. In other words, nanotube growth is not homogenous on a substrate element, but instead, the growth is concentrated on specific portions of the substrate's surface area. This is typically achieved by sputtering catalytic metals onto a discreet portion(s) of a substrate element. For example, half of a first-element nanofiber's surface area, i.e., one of the two surface areas created by bisecting the first-element nanotube along an axial plane, could be subjected to sputtering techniques, and second element nanotubes could be grown therefrom. Hierarchical structures manufactured by using a targeted sputtering method (a method that sputters metallic particles onto a selected portion of an element's surface area) generally have surface-area concentrations of nanotubes extending in a radial direction from the specific portions of the substrate fiber having metallic or nucleating particles thereon.

A hierarchical structure can be further described as a structure wherein each element is graded or ranked according to its size. It's a preferred characteristic that each subsequent-element nanotube decreases in both diameter and length from the previous element (nanotube or nanofiber). For illustration, within a particular hierarchical structure, a second-element nanotube's length and diameter are preferably less than that of the first-element nanofiber. Further, a third-element nanotube's length and diameter are preferably less than that of a second-element nanotube within the same structure. Still further, a fourth-element nanotube's length and diameter are both preferably less than a third-element nanotube within the same structure. And so on. In fact, it's the decreasing size of subsequent elements (or hierarchy of lengths and diameters of the elements) that has led to the “hierarchical” nomenclature for describing the subject invention.

Hierarchical structures can therefore be constructed so that the elements making up the structure span many orders of magnitude. For instance, the hierarchical structures can have a first-element-nanofiber diameter of up to about 7000 nanometers, and carbon or graphite fibers which have much larger diameters are also useful. Subsequent-element nanotubes (e.g., fourth or fifth-element nanotubes) can have diameters as small as about one nanometer—the structure's elements therefore spanning between three and four orders of magnitude.

Hierarchical-structure nanotubes generally have lengths ranging from about 10 nanometers to about 10 mm. Preferably, the lengths range from about 100 to about 2000 nanometers. More preferably, the lengths range from about 500 to about 10,000 nanometers.

It's well-known in the art that the diameter of a carbon nanotube is proportional to the diameter of the metal-catalyst particle used for its synthesis via CVD. So synthetic variables can be controlled in order to manufacture specific carbon-nanotube diameters. Hierarchical-structure nanotubes generally have diameters ranging from about 1 to about 300 nanometers. Preferably, the diameters range from about 10 to about 100 nanometers. More preferably, the nanotube diameters range from about 10 to about 30 nanometers.

Both singled-walled and multi-walled carbon nanotubes are employable in hierarchical structures.

Hierarchical structures preferably have many carbon nanotubes attached to a first-element nanofiber or a carbon-nanotube substrate. For instance, there are preferably a plurality of second-element nanotubes on a first-element nanofiber (the first-element fiber being a substrate for the second-element nanotube). Generally, the concentration of nanotubes on a nanofiber or nanotube substrate can range anywhere from about 1 to about 5000 nanotubes per 10⁶ nanometers² or 1 micrometer² (1 μm²) of substrate surface area. Preferably, there are from about 100 to about 1000 nanotubes on a nanofiber or nanotube substrate per 1 μm² of substrate surface area. More preferably, there are from about 500 to about 600 nanotubes on a nanofiber or nanotube substrate per 1 μm² of substrate surface area. This invention is not, however, limited by the concentration of nanotubes on a nanofiber or nanotube substrate.

Preferably, at the outer-most tip of each of a hierarchical structure's carbon nanotubes is a metal particle that served as a catalyst or nucleating agent for forming the particular nanotube. Alternatively, these metal particles can be removed by dissolution in acids or appropriate solvent that does not dissolve and chemically attack the carbon or other essential components of Hierarchical structure.

In addition to this metal particle at the outer-most tip of a carbon nanotube, there are preferably additional metallic particles on the outer surface of the carbon-nanotube walls. It's these metallic particles on the outer surface of the nanotube's outermost wall that preferably act as catalysts in growing of additional nanotubes (the next-element nanotubes) via CVD or other known means.

Preferably, the additional metallic particles are proximate or exposed on a nanotube's outer-most surface. A nonlimiting list of employable metals includes rhodium, ruthenium, manganese, chromium, copper, molybdenum, platinum, nickel, cobalt, palladium, gold, and silver.

A nanofiber is the first element of a nanofiber-based hierarchical structure and acts as the direct or indirect support structure for growing or supporting the structure's nanotubes. The hierarchical first-element nanofibers are not limited to particular compositions. But preferably, the nanofibers have been electrospun and are either carbonized or ceramic.

The nanofibers employable in hierarchical structures as support elements and substrates for growing nanotubes are not limited to any particular length or diameter. The diameters of the first-element nanofibers generally range from about 50 to about 5000 nanometers. Preferably, the first-element nanofibers' diameters generally range from about 100 to about 500 nanometers.

The first-element nanofiber lengths generally range from about 1 μm to about several kilometers. Preferably, the first-element nanofiber lengths range from about 1 mm to about 20 cm.

As a first step in preparing a hierarchical structure, at least one second-element nanotube is grown on a first-element nanofiber. It's preferred that additional steps include growing at least one third-element nanotube on a second-element nanotube. More preferably, additional subsequent-element nanotubes, e.g. fourth- and fifth-element nanotubes, are also grown.

Nanofiber substrates that are employable in the subject invention are not limited to a specific method of preparation. They are, however, preferably prepared by the electrospinning followed by heat treatment to yield a carbonized fiber or ceramic fiber.

Electrospinning is well known, and the polymers employed in an electrospinnable solution are not limited to any particular composition. The preferred electrospinnable polymer is polyacrylonitrile. Additional polymers that are employable in the electrospinnable solution include: (1) polyacrylonitrile-co-polymer, such as poly(acrylonitrile-co-acrylic acid) or poly(acrylonitrile-co-butadiene) and (2) polyacrylic acid and its co-polymer, such as poly(acrylic acid-co-maleic acid), polystyrene, poly(methyl methacrylate), or polyamic acid.

The present invention is not limited to employing a particular solvent or solvents, and any known solvent can be used in electrospinning a nanofiber.

Electrospinnable solutions preferably have a metal component. As a result of electrospinning electrospinnable solutions having a metal component, a nanofiber is produced wherein the metal component is part of the fiber. The metal-component concentration within an electrospinnable solution can be determined by persons having ordinary skill in the art without undue experimentation, based on the desired concentration of metal components in the resultant nanofiber. A nonlimiting list of preferred employable metals include iron, rhodium, ruthenium, manganese, chromium, copper, molybdenum, platinum, nickel, cobalt, palladium, gold, and silver. Other metals known for their use in catalyzing or nucleating the growth of carbon nanotubes can also be employed in the electrospinnable solutions.

A physical sputtering method can be used to deposit catalytic-metal particles on a hierarchical structure's elements (either nanofiber or nanotube). The sputtering process will significantly increase the number of metal nanoparticles per unit surface area of the fiber or nanotube.

A nonlimiting list of employable metals for sputtering include: platinum, palladium, nickel, rhodium, ruthenium, cobalt, molybdenum, iron, and other catalytic metals.

The amount of metallic components in an electrospinnable solution generally ranges from about 1% to about 80% relative to the amount of polymer in the solution. Preferably, the concentration of metallic components in an electrospinnable solution ranges from about 20% to about 50% relative to the amount of polymer in the solution.

Fibrous substrates employable in the subject invention are not limited by their method of preparation, but manufacture by electrospinning is preferred. Accordingly, other known methods for producing nanofibers can be employed. The fiber substrates are preferably then heat treated to yield a carbonized or ceramic fiber.

Carbonized or ceramic nanofibers are preferably employed as first-element nanofibers. Carbonization can be performed by any known method, and typically includes heating the subject nanofiber at a temperature ranging from about 100° C. to about 1500° C. for a time period ranging from about 2 to about 10 hours.

Carbonization of polyacryonitrile (PAN), and the reduction of the Fe³⁺ can be completed (by well-known methods) in a high temperature furnace, by the following steps: 1) 250° C. annealing in air for 3 h; 2) heating up to 500° C. at a rate of 5° C./min in argon atmosphere; 3) 500-550° C. annealing in H₂ and Ar mixture (H₂/Ar=1/3) for 4 h to reduce the Fe³⁺ to Fe; 4) heating up to 1100° C. in Ar at a rate of 5° C./min to carbonize the nanofibers, staying at the highest temperature for half an hour (for full carbonization).

A ceramic nanofiber can be synthesized using known techniques. The sol-gel method is an example of a well-known technique that is typically used to produce ceramic nanofibers. The method includes preparing the sol-gel solution by using related chemicals in a specified ratio, for example, tetraethoxysilane/ethanol/water/HCl=1/2/2/0.01; electrospinning the sol-gel solution to obtain nanofibers of a ceramic precursor; calcinating the precursor at 300-600° C. in air to produce ceramic nanofibers such as SiO₂ nanofibers. The method can also be used to produce TiO₂, Al₂O₃, B₂O₃ nanofibers and the like.

There are many well-known methods for growing nanotubes and single crystal whiskers, any of which can be employed in manufacturing hierarchical structures.

Employable catalysts include iron, nickel, cobalt, palladium, manganese, molybdenum, rhodium, ruthenium, platinum and the like. Metal catalyst can be formed on the first-element nanofiber by physical sputtering coating and by using known techniques to convert the metal compounds, contained in the electrospun nanofibers, to the metal nanoparticles. Other catalysts such as molecular catalysts can be chemically attached to the hierarchical structure.

A secondary-carbon source for the growth of nanotubes can be hexane, benzene, toluene, ethylene, ethyne and/or other hydrocarbon compounds.

For multiwall carbon nanotubes, the growth temperature is 700-800° C., and for single wall carbon nanotubes, the growth temperature is 1000-1200° C.

The presently predictable growth speed of the nanotubes is 50-2000 nm per minute. The preferable length of tubes is 500 nanometers to 10,000 microns.

The structure is useful for particle-enhanced scanning raman spectroscopy. When placed in close proximity to roughened metal surfaces, molecules can exhibit greatly enhanced Raman scattering, which has become known as surface-enhanced Raman scattering (SERS). Nanoscale surface roughness supports the electromagnetic resonances that are the dominant mechanism of enhancement. These electromagnetic resonances can increase the scattered intensity by ˜10⁴. The surface of the invented hierarchical carbon nanostructure is particularly rough. Such nanostructure coated with metal nanoparticles (by using plasma enhanced sputtering), such as silver nanoparticles, will provide ideal rough metallic surfaces for enhancing Raman spectra of molecules adsorbed on the rough metallic surface.

The structure is also useful for an electrochemical connection to the nervous system, so that signals can be directly transmitted to and received from the nervous system, in a reversible and biocompatible way. An electrical signal applied to a long fiber (electrically insulated and mechanically supported in suitable ways) will produce electrochemical spaces that are recognized as signals by appropriate parts of the nervous system, such as artificial synapses at the ends of cut axons, or even by insertion of the end of the nanofiber structure into the fluid interior of an axon.

The structure is also useful for a “filter media” for electrically modulated filtration of the liquid and gases. In other words, the hierarchical structure is employable in electrophoresis filtration systems. Dielectrophoretic filters are described in IEEE transactions on industry applications, Vol. 39, No. 5, September/October 2003, which is hereby incorporated by reference. The hierarchical structures are employable in dielectrophoretic filters as part of the electrode system, i.e., the hierarchical structures can be substituted in for the known thin-metal-film electrodes.

This structure is also useful for supporting particles (such as nanoparticles, nanocrystals, and molecules) in an electron microscope. Samples in which many of the particles are identical are particularly interesting. Protein molecules are an example. Identical protein molecules are commonplace. Each molecule “folds” into an identical structure. To determine the location of the atoms in that structure (or a less demanding but important problem, to determine the shape of the folded protein molecule) it is necessary to observe the molecule from many different directions.

Ideally the molecule should be mounted on a 3-axis goniometer with three translational axes, so that particularly revealing view directions can be aligned with the axis of the microscope and the particle can be moved so that it is centered on the microscope and at a precise point along the direction of the axis. No such goniometer exists now. Contemporary goniometers provide some awkward and difficult alternatives.

The structure, bearing the protein molecule, can be mounted on an ordinary electron microscope grid and supported in the highest quality goniometer stage available. Biochemical technology provides ways for connecting the example particles protein molecules to the metal tip or to the sides of the nanotube (or nanocrystal) that supports the tip. The electron microscope staged goniometer can be used to bring one particle at a time into view, and to perform useful but limited solutions (for example, around the axis of the nanofiber structure). The unique and very valuable capability of this invention is to support particles in a wide range of regular orientations that can be reached in a controlled way which any available goniometer stage. This results from the randomness of the direction in which the branches grow from the backbone nanofibers, and from any randomness in the way the particles are attached to the structure. The particles of most interest would be observed from a direction in which the electrons can pass through the sample without passing through the support structure.

The crystal structure of the branch or the tip can also be observed, and used as an index that would be helpful in making controlled angular adjustments without translating the particle to a position where it could be formed, positively identified and examined from another known direction.

A fuel cell in which oxygen combines with hydrogen, or in which other similar reactions occur, provides clean power to drive automobiles. The electrodes of the fuel cell are a key technology. An electrically conductive membrane structure material, supporting metal nanoparticles, having a large specific surface area, with pores or channels that permit the flow of gases and liquids through the electrode, is ideal.

The high electrical conductivity of the carbon sheet and the direct path from the tip of every nanotube to the edges and surfaces of a strong-mechanically macroscopic sheet make these hierarchical structures useful in the construction of fuel cell electrodes. Noble metal particles were attached to the surfaces of the nanotubes, by plasma enhanced sputtering, as shown in FIG. 6 (B). Each of the sputtered catalyst particles has a direct electrical path to nanofiber sheet. The large fraction of the surface area of each catalyst particle not blocked by the supporting nanotube is available for electron transferring contacts to the molecules that participate in the operation of the fuel cell. Further, the processing parameters of the growth of the hierarchical nanofibers can control the ratio of open space between the catalyst particles and the space occupied by the nanofibers carrying electrical current. It is possible to design and manufacture a fuel cell electrode, for example, in which the flow of molecules, ions, and electrons are all optimized.

Hierarchical structures can also serve as a support structure for light-harvesting or photosynthetic compounds such as carotene-porphyrin-fullerene compounds. Such a structure is commonly known as a photodiode. A hierarchical structure's electrical conductivity enables the light-harvesting compounds to act as an energy source and pass electron through the hierarchical structure to an energy-storage device or other useful structure. The light-harvesting compounds, such as a carotene-porphyrin-fullerene compounds/systems are preferably attached to a hierarichical structure's carbon nanotubes. Preferably, there is a large number or high concentration of light-harvesting compounds making up the hierarchical structure. Photosynthetic molecules such as carotene-porphyrin-fullerene compounds are known and described in Chemical and Engineering News, Vol. 81, Number 38, page 8, which is herein incorporated by reference. Dendrimers can also be attached to a hierarchical structure's nanotubes and serve as an energy source in this method of use.

### EXAMPLES

### Example 1

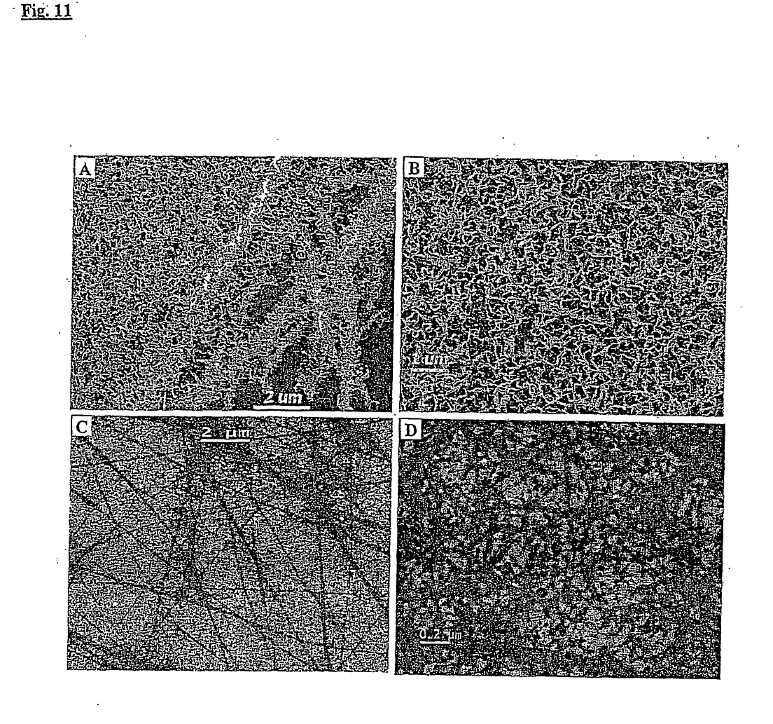

I. A schematic diagram of electrospinning device for producing polyacrylonitrile (PAN) nanofiber that contained metal compound is shown in FIG. 10. The electrical field was 100 v/per mm, from a 30 kV electrical potential applied to a 30 cm gap between the liquid polymer and the collector. Such electrospinning devices are known in the art.

Polyacrylonitrile (PAN) nanofibers that contained palladium acetate [Pd(Ac)₂], platinum acetylacetonate [Pt(Acc)₂], nickel acetylacetonate [Ni(Acc)₂], copper acetylacetonate [Cu(Acc)₂], cobalt acetylacetonante [Co(Acc)₂], iron acetylacetonante [Fe(Acc)₃], magnesium acetylacetonate [Mn(Acc)₂], chromium acetylacetonate [Cr(Acc)₃] or other such metal containing compounds, were produced by electrospinning a solution, in DMF, of PAN and one of the following metal-organic molecules: Pd(Ac)₂, Pt(Acc)₂, Ni(Acc)₂, Cu(Acc)₂, Co(Acc)₂ or Fe(Acc)₂, [Mn(Acc)₂], [Cr(Acc)₃], for example.

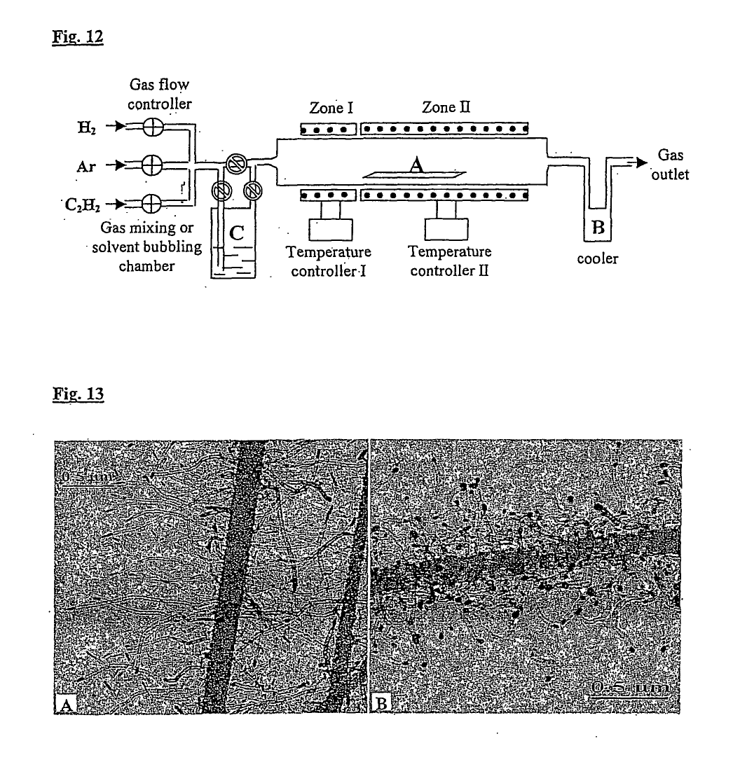

II. A schematic diagram of a high temperature furnace with a gas system for producing electrospun carbon nanofibers bearing metal nanoparticles is shown in FIGS. 11-12. The metal nanoparticles become the growing tips of carbon nanotubes. The resulting dendritic structure has carbon nanotubes with one end attached to the carbon nanofiber, and the other end terminated with a metal nanoparticle of metals known to be effective catalysts or redox electrodes. The carbon nanotube on carbon nanofiber structure is illustrated in FIGS. 1-4.

The furnace had two temperature zones. Zone I was used to preheat the flowing gas to 450° C. Zone II, at 750° C. is where the structure is created.

For example, in one experiment, electrospun polyacrylonitrile nanofibers containing a metal organic compound were put into the “A” position of the high temperature furnace. The nanofibers were heated from room temperature to 450° C. (zone II) in an Ar atmosphere flowing at the rate of 400 cc/min. Then a reducing mixture of 1 part H₂ to 3 parts Ar by volume was introduced into the furnace. After 2 hours when the metal precursor was converted to metal nanoparticles at 450° C., the temperature was heated to 750° C. (zone II) and at a rate of 5° C./min. After staying at 750° C. (zone II) for 25 min when the carbonization was completed, the furnace was cooled down to room temperature in an atmosphere of argon. These carbonized nanofibers kept their original form, a non-woven nanofiber membrane. Metal-organic compounds in the nanofibers were reduced into metal nanoparticles in and on the carbonized nanofibers. The size of the nanoparticles ranged from 2 to 50 nm for different metals. The typical diameters of Fe nanoparticles were 2 to 8 nm, Ni 5 to 15 nm, Pd 10 to 25 nm, Pt 5-15 nm, Mn 25 to 50 nm, Cu 20 to 40 nm, Co 2-8 nm, Cr 10 to 25 nm.

The following process steps formed the carbon nanotube on carbon nanofiber structure. The carbonized nanofiber membrane bearing metal nanoparticles, described as above, was put in the “A” position of the furnace. When the furnace temperature was heated to 400° C. (zone I) and 750° C. (zone II) in an argon atmosphere, the flowing argon was then directed through the bubbling chamber, which contained hexane or other liquid of molecules that contained carbon. Acetylene, ethylene, methane and other hydrocarbon compounds can be used as alternative carbon sources. After 5 minutes of bubbling, the gas flow was switched to bypass the bubbling chamber. After staying at 750° C. for 25 min, the furnace was cooled down to room temperature in an argon atmosphere.

The hexane served as the carbon source and metal nanoparticles that formed on the surface of the nanofibers during the pyrolysis of the metal organic compound served as the catalyst for the formation of carbon nanotubes. The nanotubes grew into the interstices between the somewhat larger and much longer carbon nanofibers. The metal particles remained at the growing tips of the nanotubes. The carbon nanotubes grown on the carbonized electrospun nanofibers had diameters of 10 to 60 nm, depending on the size of the original particle. The density, of the carbon nanotubes on nanofiber membrane structure, is about 0.32 g/cm³. This porous sheet had an electrical resistivity of 98Ω per square. The uncompressed thickness of the porous sheet was approximately 10 micron. The volume resistivity of the sheet was about 7.6×10⁻⁴ Ω·m.

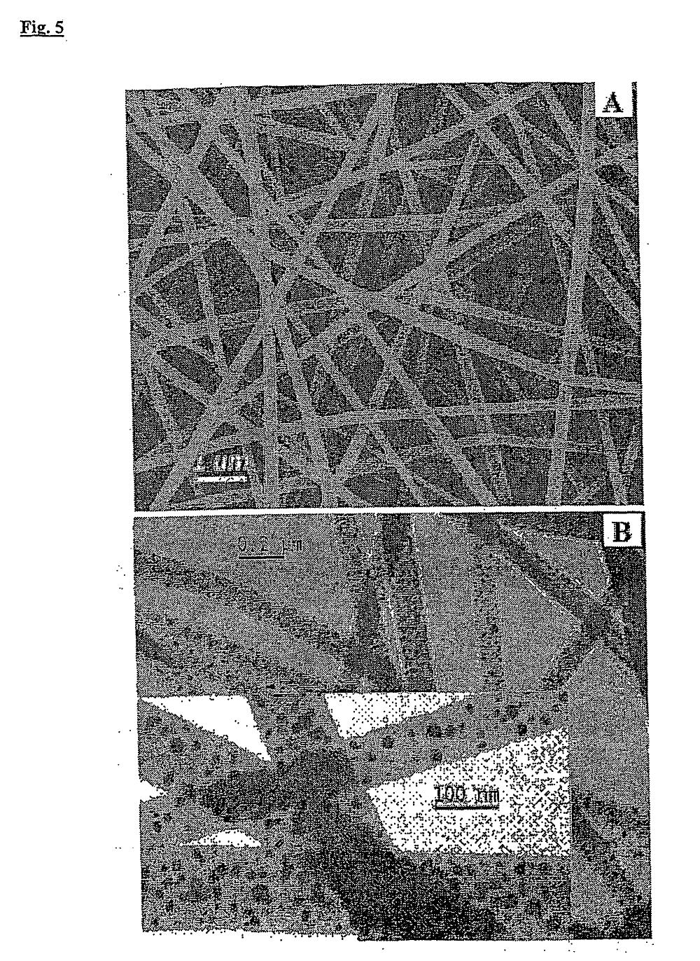

The carbon nanotubes on nanofibers membrane structure, with deposited catalytic metal particles, such as Ni nanoparticles, was used as the substrate for the formation of the second-class carbon nanotubes. The second-class carbon nanotubes were formed at 700° C. for 15 min by using toluene as the additional carbon source. The resulting hierarchical structure is shown in FIGS. 5-7.

### Example 2

Materials and Apparatus: Polyacrylonitrile (PAN) (Typical Mw 86200, Aldrich), palladium acetate [Pd(Ac)₂] (98%, Aldrich), platinum acetylacetonate [Pt(Acc)₂] (97%, Aldrich), nickel acetylacetonate [Ni(Acc)₂] (95%, Aldrich), copper acetylacetonate [Cu(Acc)₂] (97%, Aldrich), cobalt acetylacetonante [Co(Acc)₂] (98%, Aldrich), iron(II) acetylacetonante [Fe(Acc)₂] (97%, Aldrich), N,N-dimethylacetamide (DMF) (99%, Aldrich) were used as received. The electrospinning setup and the CVD apparatus are conventional and well known in the art.

Hybrid Nanofibers: A typical experiment involves dissolving an organic salt M(Ac)x or M(Acc)ₓ such as Pd(Ac)₂ into 7% wt PAN solution of DMF to make a 5% wt PAN and 5% wt M(Ac)ₓ or M(Acc)ₓ solution mixture of DMF. Hybrid electrospun nanofibers (FIGS. 1-4) were obtained by electrospinning the above solution at 30-40 kV. The electrospun hybrid nanofibers were converted to hybrid nanofibers of carbon and metal nanoparticle (FIGS. 5-7) by annealing the electrospun hybrid nanofibers in H₂ atmosphere at 800° C. for 3 hours.

Growth of Carbon Nanotubes: Hybrid carbon nanofibers with Pd nanoparticles were put into a tubular CVD furnace, in an argon atmosphere and heated to 650-700° C. Then the reactant gas acetylene (at about 1:10 ratio of Ar) was introduced and allowed to react for 5 min. The result is shown in FIG. 5.

Discussion: Polyacrylonitrile was chosen as the matrix of hybrid nanofibers due to its solubility in DMF which is a good solvent for various organic salt such as Pd(Ac)₂, Cu(Acc)₂, and its carbon forming ability. The diameters of electrospun hybrid nanofibers ranged between 100-300 nm.

Reductive hydrogen gas converted the electrospun hybrid nanofibers into nanofibers of carbon-containing metal nanoparticles. Metal ions, particularly the non-oxidative metal ion such as Fe⁺⁺, Ni⁺⁺, were reduced to metal particles by the hydrogen.

The as-prepared hybrid nanofibers of carbon and Fe, Ni, or Co metal nanoparticles are ferro magnetic and also chemically stable in air, suggesting the presence of a carbon layer covering the metal nanoparticles. The saturation magnetization Mₛ, increases as the ferromagnetic metal weight fraction of the hybrid nanofibers. The metal nanoparticles on the hybrid nanofibers can be used as catalysts either for chemical synthesis or for the synthesis of carbon nanotubes or polyacetylene. As shown in FIGS. 5-7, the as-synthesized carbon nanotubes on the hybrid nanofiber can be put on a TEM grid and observed directly using transmission electron microscopy without catalyst loss during the sample preparation. The intact carbon nanotube sample on the nanofiber substrate is an ideal sample for observation of the growth of carbon nanotubes.

### Example 3

Materials: Polyacrylonitrile (PAN) (typical Mw 86200), iron acetylacetonate (Fe(Acc)₃) (99.9%), dimethylformamide (DMF) (99.9%) and hexane (98.5%) were purchased from the Aldrich Chemical Co. Hydrogen T and Argon T were purchased from Praxair INC. All reagents were used without further purification.

Instrumentation: High temperature furnace, purchased from Lindberg HEVI-Duty, was equipped with 35×950 mm tubular quartz reactor for the carbonization of polymer nanofibers and for the formation of carbon nanotubes. ES60-0.1P Model HV power supply was purchased from Gamma High Voltage Research for electrospinning process of polymer nanofibers.

Electrospinning of composite nanofibers of PAN and Fe (Acc)₃: The electrospinning process was performed by using a 10% wt. PAN/Fe(Acc)₃ (wt. Ratio=2/1) solution of DMF and electric fields on the order of 100 kV/m, from a 30 kV electrical potential applied to a 30 cm gap between the spinneret and the collector.

Carbonization of electrospun nanofibers and the formation of carbon nanotubers on carbon nanofibers: The carbonization and reduction of Fe³⁺ of the as-electrospun composite nanofibers of PAN and Fe(Acc)₃ as well as the formation of carbon nanotubes on the carbonized electrospun nanofibers were completed in a high temperature furnace by the following steps: 1) 250° C. annealing in air for 3 h; 2) heating up to 500° C. at a rate of 5° C./min in Ar atmosphere; 3) 500-550° C. annealing in H₂ and Ar mixture (H₂/Ar=1/3) for 4 h; 4) heating up to 1100° C. in Ar atmosphere at a rate of 5° C./min, staying at the highest temperature for half an hour and then cooling down to 700° C. in Ar atmosphere; 5) introducing a hexane vapor into the 700° C. tubular reactor by using an Ar flow of 600 ml/min through a hexane bubbling chamber and maintaining the hexane vapor carbon supply for a measured time: 3 min for a short carbon nanotube, 5 min for longer tubes and 20 min. for the much longer tubes; and 6) staying at the same temperature for 30 min. after stopping the carbon source supply and then cooled down to room temperature in Ar atmosphere.

Electron microscope observation: The SEM and TEM observations were made with a JEOL JEM-5310 scanning electron microscope and a 120 kV FE1 TACNAI-12 transmission electron microscope.

### Results and Discussion

Electrospinning of composite nanofibers of PAN and Fe(Acc)₃: PAN was selected as a suitable precursor for making electrospun nanofibers since it is well known route to carbon nanofibers. As the catalyst precursor, we used Fe(Acc)₃, since Fe particle catalysts are well known to us for the formation of carbon nanotubes. Both PAN and Fe(Acc)₃ were dissolved in DMF and the solution was electrospun into composite nanofibers. The carbon precursor nanofibers are nanofibers of PAN and Fe(Acc)₃. The diameters of the as-electrospun precursor nanofibers ranged between 100 and 300 nm. A typical distribution of diameters of segments along the nanofibers is shown in FIGS. 5-7.

Carbonization of electrospun nanofibers and the formation of carbon nanotubers on carbon nanofibers. The carbonization of the precursor nanofibers and reduction of Fe³⁺ were performed by using a high temperature furnace similar to the equipment used for the catalytic gas phase growth of MWNTs reported previously. For the first step of carbonization, the oxidative stabilization of the precursor nanofibers was completed at 250° C. in air. In this treatment, thermoplastic PAN converted to non-plastic cyclic or ladder compounds. The reduction of Fe³⁺ to Fe was accomplished at 500-550° C. in an atmosphere of H₂, as reported by Wang et al. At high temperature, the Fe in the nanofiber aggregated into Fe nanoparticles. The sizes of the Fe nanoparticles are 10 to 20 nm as shown in TEM image of FIGS. 5-7.

Hexane vapor was used, in a subsequent treatment for the formation of carbon nanotubes on the iron particles on or in the carbonized electrospun nanofibers, as another carbon source. Argon, bubbled through hexane, carried the hexane vapor into the high temperature tubular reactor. At 700-750° C., the hexane molecules were decomposed on the surface of the Fe nanoparticles by the catalytic action of the metal. Decomposition products such as H were rejected. The carbon atoms were held on or in the metal particles. The carbon migrated through the metal or on the surface of the metal, and contributed to the growth of the multiwalled carbon nanotubes. It is not now established whether the metal particles melts, because of its small size, partially melts by formation of a eutectic mixture with reaction products, or absorbs the carbon on its surface. The carbon atoms or clusters of atoms moved, somehow, to the interface between the metal and the growing end of the carbon tube, where the carbon became incorporated into the tube and the metal particle was caused ahead as the carbon tube grew longer.

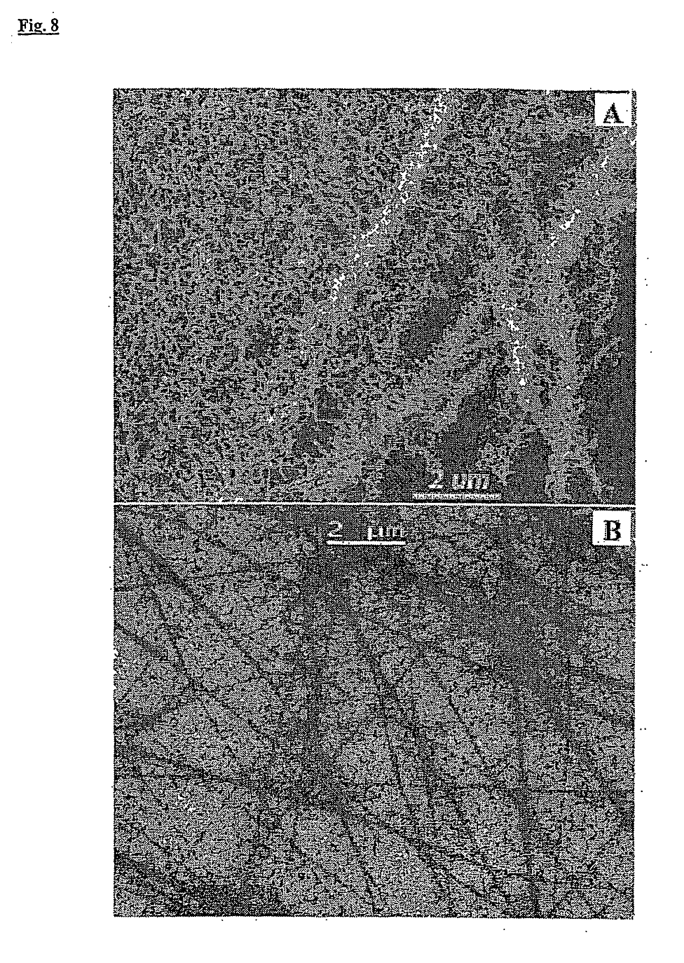

The carbon nanotubes grew into the interstices between the somewhat larger and much longer carbon nanofibers. The carbon nanotube on carbon nanofiber structure can be made in a fine sheet (FIGS. 8-10) since the electrospun non-woven nanofiber sheet can be prepared very thin. Such structures, or a sheet composed of such structures can be used for various applications such as high-performance filters, reinforced composites, highly porous carbon nano-electrodes, and for supports for samples in a transmission electron microscope. In these uses, separating the carbon nanotubes from the substrate is not necessary.

Electrospun PAN nanofibers containing Fe(Acc)₃ were successfully carbonized and the Fe³⁺ was reduced into iron nanoparticles in-situ by using reductive hydrogen gas at 500-550° C. The carbonized electrospun nanofibers were used as substrates and the metal nanoparticles formed in or on the nanofibers served as the catalyst for the formation of carbon nanotubes. The multiwalled carbon nanotubes were formed on the carbon nanofiber substrate under a catalytic growth mechanism via a CVD process. The as-formed multiwalled carbon nanotubes and their carbon nanofiber substrates formed a characteristic structure of carbon nanotubes on carbon nanofibers.

### Example 4

Polyacrylonitrile (PAN) was selected as a suitable precursor for making electrospun nanofibers since it provides a well-known route to carbon nanofibers. Fe(acetylacetonate)₃, abbreviated Fe(Acc)₃, which is soluble in organic solvents, was used as the catalyst precursor since Fe particle catalysts are often used for the formation of carbon nanotubes. PAN and Fe(Acc)₃ were dissolved together in dimethyl formamide (DMF). The solution was electrospun into PAN precursor nanofibers that contained Fe(Acc)₃. The diameters of the precursor nanofibers ranged from 100 to 300 nm. The distribution of diameters shown in FIGS. 5-7 is typical. Stereoscopic electron microscopy shows that most of the iron particles are on the surface, with only a few completely embedded in the carbon nanofiber. Embedded particles did not participate in the growth of nanotubes.

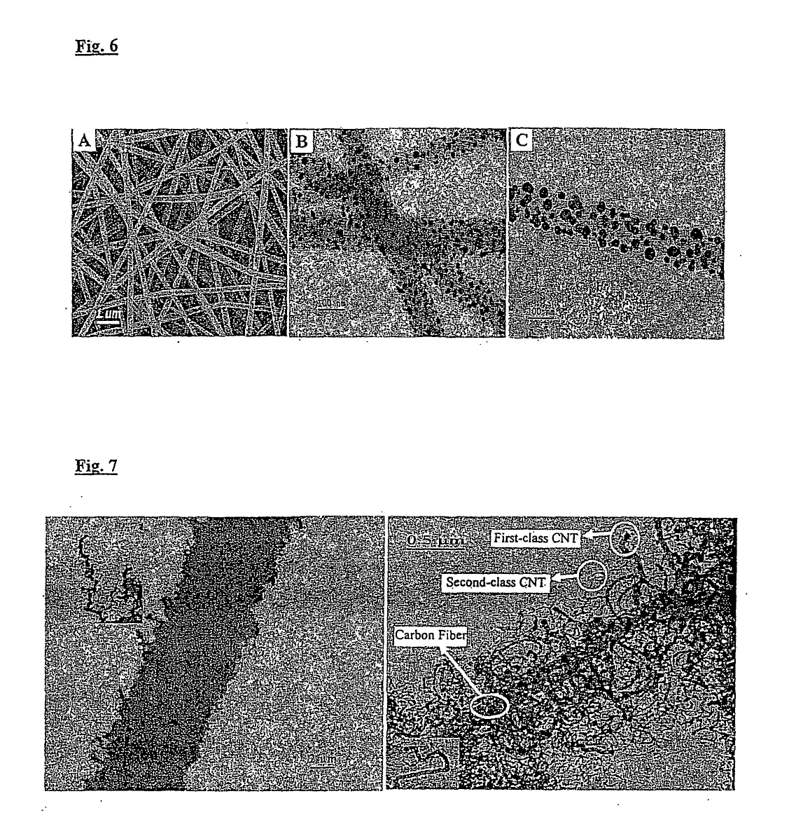

The carbonization of the PAN nanofibers and reduction of Fe³⁺ were performed in a tubular high temperature furnace similar to the furnace used for the catalytic gas phase growth of multiwall carbon nanotubes reported previously. The first step of oxidative stabilization of the precursor nanofibers was completed at 250° C. in air. In this treatment, thermoplastic PAN was converted to a non-plastic cyclic or ladder compound. The reduction of Fe³⁺ to Fe was accomplished at 500-550° C. in an atmosphere of H₂, as reported by Li et al. During the carbonization and reduction treatments, the Fe in a nanofiber aggregated into nanoparticles. The size range of the Fe nanoparticles was 10 to 20 nm as shown in FIG. 6. A higher concentration of Fe(Acc)₃ in PAN nanofibers resulted in larger Fe nanoparticles as shown in FIG. 7.

Hexane vapor was used as a source of carbon for the formation of carbon nanotubes. Argon, bubbled through hexane, carried the hexane vapor into the tubular high temperature furnace. At 700° C., the hexane molecules were decomposed on the surface of the Fe nanoparticles by the catalytic action of the metal. The carbon atoms were absorbed on and dissolved in the metal, transported to the interface between the iron particle and the growing end of the graphitic carbon nanotube, and incorporated into the tube. The metal particle was carried ahead as the nanotube grew longer. It is worth noting that although the observed morphology of the growth process appears to be similar to the vapor-liquid-solid process, 700° C. is far below the eutectic temperature (1154° C.) in the iron carbon phase diagram. The lowering of the melting temperature of a small particle due to surface tension does not provide a satisfactory explanation. A formula given by Benisaad et al. Tₘ=Tₑ−400/d, indicates that the lowering of the melting temperature, for an iron particle with a diameter more than 10 nm, cannot account for the existence of a liquid phase at the temperature of 700° C. (In Benisaad's formula, Tₘ is the melting point of the iron-carbon particle; Tₑ is the eutectic temperature in the iron-carbon phase diagram; d is the diameter of the carbon-iron particle measured in nm) Atoms of other elements could affect the liquefaction of the iron-carbon particles. Hydrogen is implicated by its presence from the decomposition of the hexane, and by its known ability to “embrittle” iron. Carbon transport mechanisms required for solid-solid phase transformation in this temperature range offer another possibility. The catalyst particles observed here are supported in an almost ideal way for observation with electron microscopy and diffraction, which might reveal new information about the growth mechanism of carbon nanotubes and about the iron, carbon, and hydrogen ternary phase diagram.

The length of the carbon nanotubes on the carbon nanofibers depended on the length of time the hexane vapor was supplied. Longer times yielded longer carbon nanotubes, and shorter times yielded shorter carbon nanotubes (FIGS. 8-10).

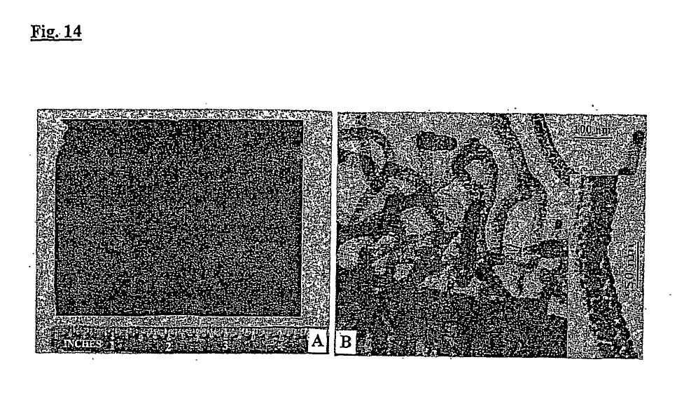

The CNT-CNF structure was made in the form of a sheet by first making a thin sheet of iron bearing carbon nanofibers. Then carbon nanotubes were grown into the interstices between the somewhat larger and much longer carbon nanofibers. The carbon nanotubes were dispersed, around 200 nm apart, throughout the thin sheet. The nanotubes dramatically reduced the sizes of the open paths through the structure, as shown in FIGS. 11-12. The SEM images show that the longer carbon nanotubes are bent and tangled. Several processes for the growth of the helically coiled carbon nanotubes were reported. Nanotubes grown at higher temperatures tends to have higher long-range crystalline order. The carbon nanotube on carbon nanofiber structure shown in FIG. 13 (A) was made at 850° C. The nanotubes are much straighter than those in FIG. 13 (B), which formed at 700° C.

Self-supporting CNT-CNF sheets with areas of more than 100 cm² and with mass per unit area of 2.95 g/m² were made (FIG. 6 (A)). The uncompressed thickness of the porous sheet was approximately 10 micron. The pore volume of such a sheet is around 86%. This porous sheet had an electrical resistivity of 98Ω per square. The volume resistivity of such a porous sheet was about a resistivity of 7.6×10⁻⁴Ω·m. The lateral size of the sheet was limited by the size of the tubular furnace.

Experimental: The electrospinning process was performed by using a polyacrylonitrile (PAN) and Fe(Acc)₃ mixture solution in dimethyl formamide. The PAN and Fe(Acc)₃ is 6.7% and 3.3%, respectively, by weight in the solution. The electric fields were on the order of 100 kV/m, from a 30 kV electrical potential applied to a 30 cm gap between the spinneret and the collector. Stabilization and carbonization of PAN, and the reduction of the Fe³⁺ were completed in a high temperature furnace, by the following steps: 1) 250° C. annealing in air for 3 h; 2) heating up to 500° C. at a rate of 5° C./min in an argon atmosphere; 3) 500-550° C. annealing in a mixture of H₂ and Ar mixture (H₂/Ar=1/3) for 4 h to reduce the Fe³⁺ to Fe; 4) heating up to 1100° C. in Ar at a rate of 5° C./min to carbonize the nanofibers, staying at the highest temperature for half an hour, and then cooling to 700° C. in Ar. Nanotubes grew when hexane vapor was introduced into the 700° C. tubular reactor by bubbling the Ar flow of 600 ml/min through hexane at room temperature. The hexane vapor was supplied for measured times: 3 min for a short carbon nanotube, 5 min for longer tubes and 20 min for the longest tubes. The temperature was held constant for 30 min after stopping the hexane vapor supply and then cooled to room temperature in Ar. Images were made with a JEOL JEM-5310 scanning electron microscope and a 120 kV FEI TECHNAI-12 transmission electron microscope.

1. A composition comprising:
a first nanotube attached to a fiber.

2. The composition of claim 1, wherein the first nanotube has a diameter ranging from about 30 to about 300 nanometers.

3. The composition of claim 1, wherein the first nanotube has a length ranging from about 10 to about 10,000 nanometers.

4. The composition of claim 1, wherein the first nanotube is single-walled or multi-walled.

5. The composition of claim 1, wherein the first nanotube comprises a metal.

6. The composition of claim 5, wherein the metal is rhodium, ruthenium, manganese, chromium, copper, molybdenum, platinum, nickel, cobalt, palladium, gold, or silver.

7. The composition of claim 1, wherein the fiber is an electrospun fiber.

8. The composition of claim 1, wherein the fiber is ceramic, carbonized, elemental, or a chemically tractable metal.

9. The composition of claim 1, wherein the fiber is boron nitride, boron carbide, nitrogen carbide, or silicon.

10. The composition of claim 1, wherein a second nanotube is attached to the first nanotube.

11. A composition comprising:
a second nanotube attached to a first nanotube.

12. A method comprising the step of:
growing a nanotube on a fiber substrate.

13. The method of claim 11, wherein the fiber substrate is an electrospun fiber.

14. The method of claim 11, wherein the fiber substrate is ceramic, carbonized, elemental, or a chemically tractable metal.

15. A method comprising the step of:
growing a second nanotube on a first nanotube substrate.

16. The method of claim 14, wherein the second nanotube has a diameter that is less than that of the first nanotube substrate.

17. A method comprising the step of:
using the composition of claim 1 as an electrode.

18. A method comprising the step of:
using the composition of claim 1 as a filtration device.

19. The composition of claim 17, wherein the filtration device has interstices greater than or equal to about two nanometers.

20. A method comprising the step of:
using the composition of claim 1 as an electrochemical connection to the nervous system or an electrochemical connection to the interior of a living cell.

21. A method comprising the step of:
using the composition of claim 1 as a support structure for compounds having characteristic dimensions ranging from about 1 to about 100 nanometers.

22. A method comprising the step of:
performing Raman spectroscopy using the composition of claim 1 as a support structure.

23. A method for manufacturing a metal-containing nanofiber comprising the steps of:
electrospinning a solution comprising an electrospinnable polymer and at least one metal to produce a metal-containing nanofiber; and
carbonizing the resultant metal-containing nanofiber.

24. The method of claim 22, wherein the electrospinnable polymer is polyacrylonitrile.

25. The method of claim 22, wherein the metal is a noble metal.

26. The method of claim 22, wherein the metal is Ag, Fe, Pd, Ni, or Co.

27. A method comprising:
using a hierarchical structure as a fuel-cell electrode.

28. A method comprising:
using a hierarchical structure in an electrophoresis filtration system.

29. A method comprising:
using a hierarchical structure as a conductive medium in a photodiode.

30. The method of claim 28 wherein a carotene-porphyrin-fullerene compound is attached to method for using a hierarchical structure.

31. The method of claim 28, wherein a dendrimer is attached to the hierarchical structure.

32. A method comprising:
using a hierarchical structure in a battery.
